(19) United States
(12) Patent Application Publication
(10) Pub. No.: US 2025/0337543 A1
(43) Pub. Date: Oct. 30, 2025

(54) COMMUNICATION METHOD, USER EQUIPMENT AND MODEM CHIP USING THE SAME

(71) Applicant: MEDIATEK INC., Hsinchu City (TW)

(72) Inventors: Cheng-Rung Tsai, Hsinchu City (TW); Sandeep Bhat, Bengaluru KA (IN)

(21) Appl. No.: 19/190,899

(22) Filed: Apr. 28, 2025

(30) Foreign Application Priority Data
Apr. 30, 2024 (IN) 202421034265

(51) Int. Cl. H04L 5/00; H04W 72/232

(52) U.S. Cl. CPC H04L 5/0048; H04W 72/232

(57) ABSTRACT

A communication method, a user equipment and a modem chip using the same are provided. The communication method comprises: receiving, through RRC (Radio Resource Control) signaling, a first configuration of an aperiodic trigger state and a second configuration of a value of M from a network, wherein the first configuration provides a configured set of X CRI(s); receiving a DCI (Downlink Control Information) indicating the aperiodic trigger state by a CSI (Channel State Information) request field in the DCI; and reporting, to the network, M-X CRI(s) based on a CSI-RS resource set associated with the aperiodic trigger state.

This application claims the benefit of India provisional application Serial No. 202421034265, filed Apr. 30, 2024, the disclosure of which is incorporated by reference herein in its entirety.

### TECHNICAL FIELD

The disclosure relates in general to an operation method and an electronic device using the same, and more particularly to a communication method, a user equipment and a modem chip using the same.

### BACKGROUND

In the wireless communication technology, a user equipment (UE) could be configured with a CSI-RS (Channel State Information Reference Signal) resource set containing K CRI (CSI-RS resources indicator). CSI is crucial in wireless communication systems as it describes the characteristics of the wireless channel between the transmitter and receiver. CRI is a parameter in CSI reporting that helps a 5G NR UE indicate the best CSI-RS resource for downlink transmission.

The UE will report M CRI(s) and other report quantities corresponding to M CRI(s) from the K CRI(s). M is less than or equal to K. In traditional, all of the M CRI(s) are selected by the UE, and cannot be indicated by the network.

### SUMMARY

The disclosure is directed to a communication method, a user equipment and a modem chip using the same. By using a configured set, the network could actively specify which CRI(s) (CSI-RS resources indicator(s)) need to be reported based on demand.

According to one embodiment, a communication method for a user equipment is provided. The communication method comprises: receiving, through RRC (Radio Resource Control) signaling, a first configuration of an aperiodic trigger state and a second configuration of a value of M from a network, wherein the first configuration provides a configured set of X CRI(s); receiving a DCI (Downlink Control Information) indicating the aperiodic trigger state by a CSI (Channel State Information) request field in the DCI; and reporting, to the network, M-X CRI(s) based on a CSI-RS resource set associated with the aperiodic trigger state.

According to alternative embodiment, a user equipment is provided. The user equipment is used for executing a communication method. The communication method comprises: receiving, through RRC (Radio Resource Control) signaling, a first configuration of an aperiodic trigger state and a second configuration of a value of M from a network, wherein the first configuration provides a configured set of X CRI(s); receiving a DCI (Downlink Control Information) indicating the aperiodic trigger state by a CSI (Channel State Information) request field in the DCI; and reporting, to the network, M-X CRI(s) based on a CSI-RS resource set associated with the aperiodic trigger state.

According to another embodiment, a modem chip is provided. The modem chip is disposed in a user equipment. The user equipment is used for executing a communication method. The communication method comprises: receiving, through RRC (Radio Resource Control) signaling, a first configuration of an aperiodic trigger state and a second configuration of a value of M from a network, wherein the first configuration provides a configured set of X CRI(s); receiving a DCI (Downlink Control Information) indicating the aperiodic trigger state by a CSI (Channel State Information) request field in the DCI; and reporting, to the network, M-X CRI(s) based on a CSI-RS resource set associated with the aperiodic trigger state.

### BRIEF DESCRIPTION OF THE DRAWINGS

FIG. 1 shows a schematic diagram of a wireless communication system according to an embodiment of the present disclosure.

FIG. 2 shows a flowchart of a communication method for a user equipment (UE) according to one embodiment of the present disclosure.

FIG. 3 illustrates an aperiodic trigger state according to one embodiment of the present disclosure.

FIG. 4 illustrates an example to execute the steps S130 and S140.

FIG. 5 illustrates another example to execute the steps S130 and S140.

FIG. 6 illustrates another example to execute the steps S130 and S140.

FIG. 7 illustrates the UE in accordance with an implementation of the present disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

The technical terms used in this specification refer to the idioms in this technical field. If there are explanations or definitions for some terms in this specification, the explanation or definition of this part of the terms shall prevail. Each embodiment of the present disclosure has one or more technical features. To the extent possible, a person with ordinary skill in the art may selectively implement some or all of the technical features in any embodiment, or selectively combine some or all of the technical features in these embodiments.

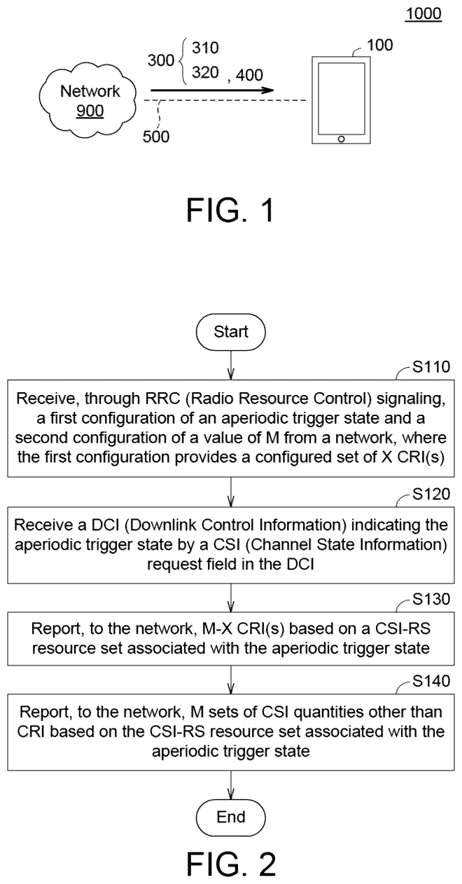

Please refer to FIG. 1, which shows a schematic diagram of a wireless communication system 1000 according to an embodiment of the present disclosure. The wireless communication system 1000 may be a long term evolution (Long Term Evolution, LTE) system, a fifth-generation mobile communication technology 5G new radio (new radio, NR) system, a machine to machine (Machine To Machine, M2M) system, or a future evolved sixth-generation communication system. The wireless communication system 1000 includes a user equipment (UE) 100 and a network 900. The network 900 and the UE 100 establish a radio connection through a radio air interface. The radio air interface may be a radio air interface based on an LTE standard, or the radio air interface is a radio air interface based on a 5G standard. For example, the radio air interface is NR, or the radio air interface may be a radio air interface based on a 5G-based technology standard of a more next-generation mobile communication network.

The UE 100 may be a mobile terminal, for example, a mobile phone or a computer that has a mobile terminal, for example, a portable, pocket-sized, handheld, computer built-in, or vehicle-mounted mobile apparatus.

Please refer to FIG. 2, which shows a flowchart of a communication method for the UE 100 according to one embodiment of the present disclosure. In the present disclosure, the communication method for the UE 100 is executed for CSI-RS Resource Indicator (CRI) based CSI Acquisition. The communication method for the UE 100 includes, for example, steps S110 to S140.

In the step S110, as shown in the FIG. 1, the UE 100 receives, through RRC (Radio Resource Control) signaling 500, a first configuration 310 of an aperiodic trigger state 200i and a second configuration 320 of a value of M of a trigger state configuration 300 from the network 900. The first configuration 310 provides a configured set of X CRI(s).

The trigger state configuration 300 in 5G NR (New Radio) is a mechanism used to control the reporting of CSI, specifically for Aperiodic CSI Reporting. It determines when and how the UE 100 should report CSI based on certain conditions or triggers sent by the network 900.

The trigger state configuration 300 is used to: enable dynamic CSI reporting when needed, rather than relying on periodic reports, reduce unnecessary signaling overhead by sending CSI only when required, and optimize network performance by ensuring CSI is updated based on real-time channel conditions.

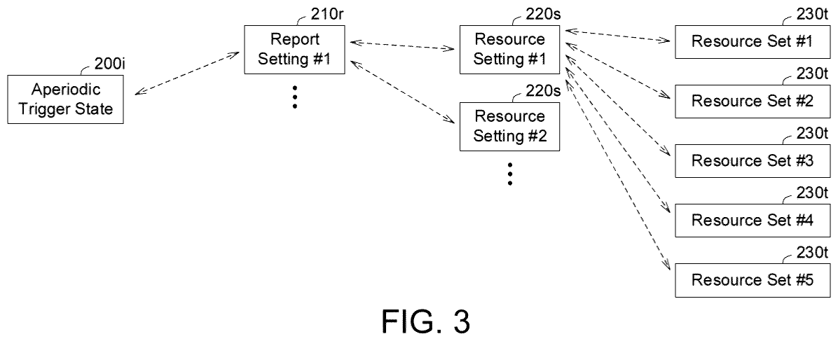

Please refer to FIG. 3, which illustrates an aperiodic trigger state 200i according to one embodiment of the present disclosure. The trigger state configuration 300 consists of a plurality of key elements, such as one or more aperiodic trigger state(s) 200i, one or more report setting(s) 210r, one or more resource setting(s) 220s, and one or more resource set(s) 230t. The CSI-RS resource set 230t associated with the aperiodic trigger state 200i comprises K CSI-RS resources, wherein K is larger than or equal to M. The aperiodic trigger state 200i is a predefined condition that determines when CSI reporting is triggered. The report setting 210r configures how the UE 100 should report aperiodic CSI when triggered. The resource setting 220s defines the CSI-RS resources used for measurement when CSI is triggered. The resource set 230t is a group of CSI-RS resources that the UE 100 can use for CSI reporting.

Next, in the step S120, as shown in the FIG. 1, the UE 100 receives a DCI (Downlink Control Information) 400 indicating the aperiodic trigger state 200i by a CSI request field in the DCI 400.

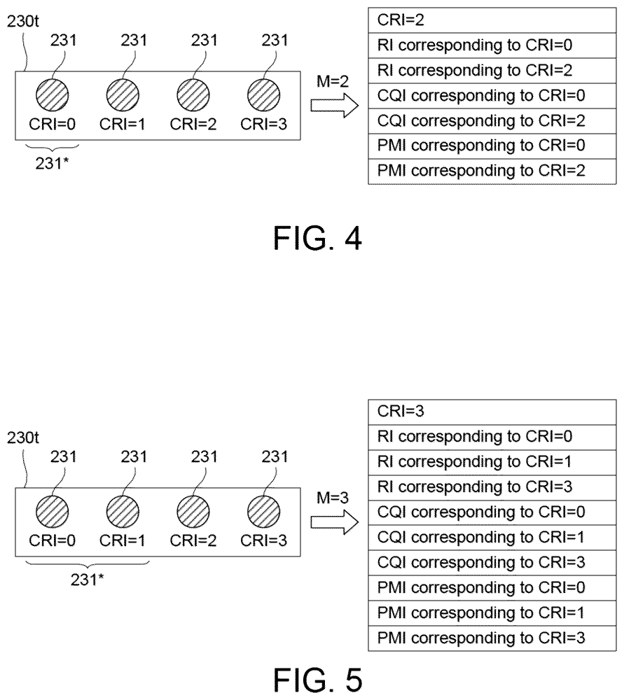

Then, please refer to FIG. 4, which illustrates an example to execute the steps S130 and S140. In the step S130, as shown in the FIG. 4, the UE 100 reports, to the network 900, M-X CRI(s) 231 based on a CSI-RS resource set 230t associated with the aperiodic trigger state 200i. X is a positive integer number. The configured set 231* indicates X and a combination of the X CRI(s) 231 to be selected for reporting. For example, the configure set 231* shown in the FIG. 4 indicates that X is “1” and “CRI=0” should be reported.

Next, in the step S140, as shown in the FIG. 4, the UE 100 reports, to the network 900, M sets of CSI quantities other than CRI 231 based on the CSI-RS resource set 230t associated with the aperiodic trigger state 200i. M is a positive integer number configured in the aperiodic trigger state 200i. X is smaller than M. As the example shown in the FIG. 4, M=2 and X=1. The M CRI(s) 231 reported by the UE 100 include the X CRI(s) 231 indicated by the configured set 231* to be reported and M-X CRI(s) 231 selected by the UE 100 to be reported. For example, as shown in the FIG. 4, “CRI=0” and “CRI=2” are two CRIs 231 reported by the UE 100. “CRI=0” is the CRI 231 indicated by the configured set 231* to be reported and “CRI=2” is the CRI 231 selected by the UE 100 to be reported.

The configured set 231* indicating the X CRI(s) indicated to be reported could be provided in CSI-AssociatedReportConfigInfo information element of the first configuration 310. Different aperiodic trigger states 200i may provide different combinations of the X CRI(s) 210 indicated to be reported. Or, X could be different in different aperiodic trigger states 200i. The network 900 could trigger one of the aperiodic trigger states 200i on demand.

For example, a CSI-RS resource set 230t containing 4 CRIs 231, and M=3 is configured.

In an aperiodic trigger state 200i labeled #1, “CRI={0, 1}” are two CRIs 231 indicated to be reported.

In an aperiodic trigger state 200i labeled #2, “CRI={1, 2}” are two CRIs 231 indicated to be reported.

In an aperiodic trigger state 200i labeled #3, “CRI={2, 3}” are two CRIs 231 indicated to be reported.

In an aperiodic trigger state 200i labeled #4, “CRI={0, 3}” are two CRIs 231 indicated to be reported.

In an aperiodic trigger state 200i labeled #5, none of the CRIs is indicated to be reported.

By using the configured set 231*, the network 900 could actively specify which CRIs 231 need to be reported based on demand.

If the configured set 231* indicating the X CRI(s) 231 indicated to be reported is present/provided, M-X CRI(s) 231 is fully selected by the UE 100. Then, the reporting order would be:
the first CRI 231 selected by the UE 100, the second CRI 231 selected by the UE 100, . . . , the (M-X)-th CRI 231 selected by the UE 100;
the first other quantity corresponding to the first CRI 231 indicated by the network 900, the first other quantity corresponding to the CRI 231 indicated by the network 900, . . . , the first other quantity corresponding to X-th CRI 21 indicated by the network 900;
the first other quantity corresponding to the CRI 231 selected by the UE 100, the first other quantity corresponding to the second CRI 231 selected by the UE 100, . . . , the first other quantity corresponding to the (M-X)-th CRI 231 selected by the UE 100;
the second other quantity corresponding to the CRI 231 indicated by the network 900, the second other quantity corresponding to the second CRI 231 indicated by the network 900, . . . , the second other quantity corresponding to the X-th CRI 231 indicated by the network 900;
the second other quantity corresponding to the first CRI 231 selected by the UE 100, the second other quantity corresponding to the second CRI 231 selected by the UE 100, . . . , the second other quantity corresponding to the (M-X)-th CRI 231 selected by the UE 100.
the Q-th other quantity corresponding to the first CRI 231 indicated by the network, the Q-th other quantity corresponding to the second CRI 231 indicated by the network 900, . . . , the Q-th other quantity corresponding to the X-th CRI 231 indicated by the network 900;
the Q-th other quantity corresponding to the first CRI selected by the UE 100, the Q-th other quantity corresponding to the second CRI 231 selected by the UE 100, . . . , the Q-th other quantity corresponding to the (M-X)-th CRI 231 selected by the UE 100.

The CRI quantity other than CRI includes, for example, at least RI (Rank Indicator), CQI (Channel Quality Indicator) and PMI (Precoding Matrix Indicator). RI indicates the number of independent data streams (layers) that the UE 100 can support. The CQI reports the best modulation and coding scheme (MCS) for optimal data rate. PMI is used to suggest how the base station should apply beamforming.

As shown in the reporting format in the FIG. 4, “CRI=2” which is the first CRI 231 selected by the UE 100; RI corresponding to “CRI=0” which is the CRI 231 indicated by the network 900; RI corresponding to “CRI=2” which is the CRI 231 selected by the UE 100; CQI corresponding to “CRI=0” which is the CRI 231 indicated by the network 900; CQI corresponding to “CRI=2” which is the CRI 231 selected by the UE 100; PMI corresponding to “CRI=0” which is the CRI 231 indicated by the network 900; PMI corresponding to “CRI=2” which is the CRI 231 selected by the UE 100 are reported.

Please refer to FIG. 5, which illustrates another example to execute the steps S130 and S140. The configure set 231* shown in the FIG. 5 indicates X=2 and “CRI=0, CRI=1” should be reported. “CRI=0” and “CRI=1” are the two CRIs 231 indicated by the configured set 231* to be reported and “CRI=3” is the CRI 231 selected by the UE 100 to be reported.

As shown in the reporting format in the FIG. 5, “CRI=3” which is the first CRI 231 selected by the UE 100; RI corresponding to “CRI=0” which is the CRI 231 indicated by the network 900; RI corresponding to “CRI=1” which is the CRI 231 indicated by the network 900; RI corresponding to “CRI=3” which is the CRI 231 selected by the UE 100; CQI corresponding to “CRI=0” which is the CRI 231 indicated by the network 900; CQI corresponding to “CRI=1” which is the CRI 231 indicated by the network 900; CQI corresponding to “CRI=3” which is the CRI 231 selected by the UE 100; PMI corresponding to “CRI=0” which is the CRI 231 indicated by the network 900; PMI corresponding to “CRI=1” which is the CRI 231 indicated by the network 900; PMI corresponding to “CRI=3” which is the CRI 231 selected by the UE 100 are reported.

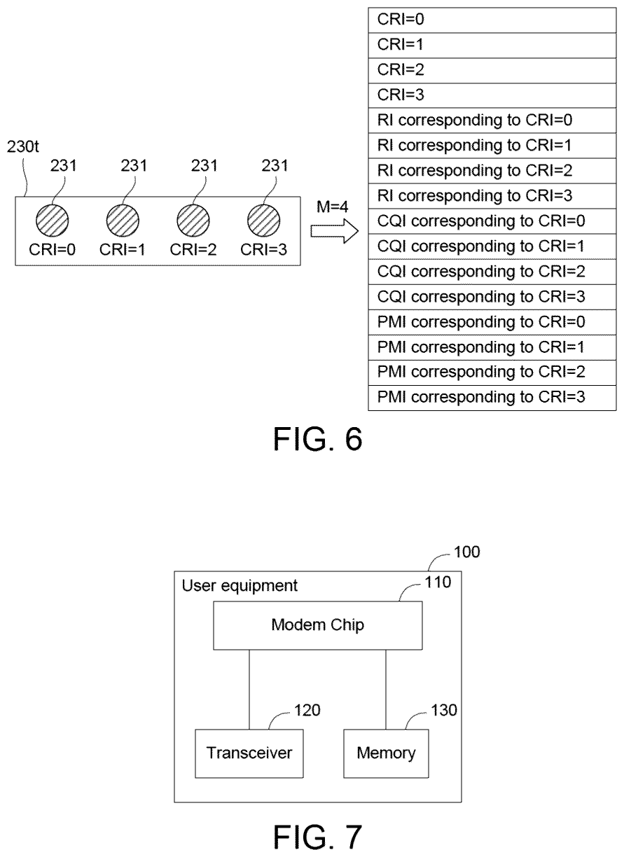

Please refer to FIG. 6, which illustrates another example to execute the steps S130 and S140. The configure set 231* shown in the FIG. 6 indicates X=0 and none of the CRIs 231 should be reported. “CRI=0”, “CRI=1”, “CRI=2” and “CRI=3” are the CRIs 231 selected by the UE 100 to be reported.

As shown in the reporting format in the FIG. 6, “CRI=0” which is the first CRI 231 selected by the UE 100; “CRI=1” which is the first CRI 231 selected by the UE 100; “CRI=2” which is the first CRI 231 selected by the UE 100; “CRI=3” which is the first CRI 231 selected by the UE 100; RI corresponding to “CRI=0” which is the CRI 231 selected by the UE 100; RI corresponding to “CRI=1” which is the CRI 231 selected by the UE 100; RI corresponding to “CRI=2” which is the CRI 231 selected by the UE 100; RI corresponding to “CRI=3” which is the CRI 231 selected by the UE 100; CQI corresponding to “CRI=0” which is the CRI 231 selected by the UE 100; CQI corresponding to “CRI=1” which is the CRI 231 selected by the UE 100; CQI corresponding to “CRI=2” which is the CRI 231 selected by the UE 100; CQI corresponding to “CRI=3” which is the CRI 231 selected by the UE 100; PMI corresponding to “CRI=0” which is the CRI 231 selected by the UE 100; PMI corresponding to “CRI=1” which is the CRI 231 selected by the UE 100; PMI corresponding to “CRI=2” which is the CRI 231 selected by the UE 100; PMI corresponding to “CRI=3” which is the CRI 231 selected by the UE 100 are reported.

Please refer to FIG. 7, which illustrates the UE 100 in accordance with an implementation of the present disclosure. The UE 100 may perform various functions to implement schemes, techniques, processes and methods described herein pertaining to UE behavior in mobile communications, including the various schemes described above with respect to various proposed designs, concepts, schemes, systems and methods described above, including the network environment, as well as processes described below.

The UE 100 may be a part of an electronic apparatus, which may be a network apparatus, such as a portable or mobile apparatus, a wearable apparatus, a vehicular device or a vehicle, a wireless communication apparatus or a computing apparatus. For instance, the UE 100 may be implemented in a smartphone, a smart watch, a personal digital assistant, an electronic control unit (ECU) in a vehicle, a digital camera, or a computing equipment such as a tablet computer, a laptop computer or a notebook computer. The UE 100 may also be a part of a machine type apparatus, which may be an loT apparatus such as an immobile or a stationary apparatus, a home apparatus, a roadside unit (RSU), a wire communication apparatus or a computing apparatus. For instance, the UE 100 may be implemented in a smart thermostat, a smart fridge, a smart door lock, a wireless speaker or a home control center. When implemented in or as a network apparatus, the UE 100 may be implemented in an eNodeB in an LTE, LTE-Advanced or LTE-Advanced Pro network or in a gNB or TRP in a 5G network, an NR network or an loT network.

In some implementations, the UE 100 may be implemented in the form of one or more integrated-circuit (IC) chips such as, for example and without limitation, one or more single-core processors, one or more multi-core processors, one or more complex-instruction-set-computing (CISC) processors, or one or more reduced-instruction-set-computing (RISC) processors. In the various schemes described above, the UE 100 may be implemented in or as a network apparatus. The UE 100 may include at least some of those components shown in the FIG. 7, such as a modem (modulator-demodulator) chip 110, a transceiver 120 and a memory 130, for example. The UE 100 may further include one or more other components not pertinent to the proposed scheme of the present disclosure (e.g., internal power supply, display device and/or user interface device).

The modem chip 110 is responsible for processing digital signals and handling the core communication protocols. It converts digital data into a format suitable for transmission over a wireless medium and vice versa. The function of the modem chip 110 includes baseband processing, error correction, MAC layer processing, protocol stack processing and interface to application processor.

The transceiver 120 is a hardware module that handles RF (radio frequency) signal transmission and reception. It operates in the RF domain, converting signals between baseband and RF frequencies. The functions of the transceiver 120 includes RF signal conversion, frequency upconversion/downconversion, power amplification, low-noise amplification (LNA), and filtering & duplexing.

In some embodiments, the modem chip 110 and the transceiver 120 are integrated into a single chipset. In other embodiments, the transceiver 120 may be a separate module.

The memory 130 is coupled to the modem chip 110 and stores data therein. The memory 130 may include a type of random-access memory (RAM) such as dynamic RAM (DRAM), static RAM (SRAM), thyristor RAM (T-RAM) and/or zero-capacitor RAM (Z-RAM). Alternatively, or additionally, the memory 113 may include a type of read-only memory (ROM) such as mask ROM, programmable ROM (PROM), erasable programmable ROM (EPROM) and/or electrically erasable programmable ROM (EEPROM). Alternatively, or additionally, the memory 130 may include a type of non-volatile random-access memory (NVRAM) such as flash memory, solid-state memory, ferroelectric RAM (FeRAM), magnetoresistive RAM (MRAM) and/or phase-change memory.

The modem chip 110 of the UE 100, is configured to perform operations described as above.

The above disclosure provides various features for implementing some implementations or examples of the present disclosure. Specific examples of components and configurations (such as numerical values or names mentioned) are described above to simplify/illustrate some implementations of the present disclosure. Additionally, some embodiments of the present disclosure may repeat reference symbols and/or letters in various instances. This repetition is for simplicity and clarity and does not inherently indicate a relationship between the various embodiments and/or configurations discussed.

It will be apparent to those skilled in the art that various modifications and variations can be made to the disclosed embodiments. It is intended that the specification and examples be considered as exemplars only, with a true scope of the disclosure being indicated by the following claims and their equivalents.

What is claimed is:

1. A communication method for a user equipment, comprising:
receiving, through RRC (Radio Resource Control) signaling, a first configuration of an aperiodic trigger state and a second configuration of a value of M from a network, wherein the first configuration provides a configured set of X CRI(s);
receiving a DCI (Downlink Control Information) indicating the aperiodic trigger state by a CSI (Channel State Information) request field in the DCI; and
reporting, to the network, M-X CRI(s) based on a CSI-RS resource set associated with the aperiodic trigger state.

2. The communication method for the user equipment according to claim 1, wherein X is smaller than M.

3. The communication method for the user equipment according to claim 1, wherein the configured set indicates a combination of the X CRI(s) to be selected for reporting.

4. The communication method for the user equipment according to claim 1, wherein the CSI-RS resource set associated with the aperiodic trigger state comprises K CSI-RS resources, wherein K is larger than or equal to M.

5. The communication method for the user equipment according to claim 1, further comprises:
reporting, to the network, M sets of CSI quantities other than CRI based on the CSI-RS resource set associated with the aperiodic trigger state.

6. The communication method for the user equipment according to claim 5, wherein the CSI quantities other than CRI includes at least RI, PMI, and CQI.

7. The communication method for the user equipment according to claim 1, wherein the configured set of X CRI(s) is provided in a CSI-AssociatedReportConfigInfo information element of the first configuration.

8. A user equipment, wherein the user equipment is used for executing a communication method, and the communication method comprises:
receiving, through RRC (Radio Resource Control) signaling, a first configuration of an aperiodic trigger state and a second configuration of a value of M from a network, wherein the first configuration provides a configured set of X CRI(s);
receiving a DCI (Downlink Control Information) indicating the aperiodic trigger state by a CSI (Channel State Information) request field in the DCI; and
reporting, to the network, M-X CRI(s) based on a CSI-RS resource set associated with the aperiodic trigger state.

9. The user equipment according to claim 8, wherein X is smaller than M.

10. The user equipment according to claim 8, wherein the configured set indicates a combination of the X CRI(s) to be reported selected for reporting.

11. The user equipment according to claim 8, wherein the CSI-RS resource set associated with the aperiodic trigger state comprises K CSI-RS resources, wherein K is larger than or equal to M.

12. The user equipment according to claim 8, wherein the communication method comprises further comprises:
reporting, to the network, M sets of CSI quantities other than CRI based on the CSI-RS resource set associated with the aperiodic trigger state.

13. The user equipment according to claim 12, wherein the CSI quantities other than CRI includes at least RI, PMI, and CQI.

14. The user equipment according to claim 8, wherein the configured set of X CRI(s) is provided in a CSI-AssociatedReportConfigInfo information element of the first configuration.

15. A modem chip disposed in a user equipment, wherein the user equipment is used for executing a communication method, and the communication method comprises:
receiving, through RRC (Radio Resource Control) signaling, a first configuration of an aperiodic trigger state and a second configuration of a value of M from a network, wherein the first configuration provides a configured set of X CRI(s);
receiving a DCI (Downlink Control Information) indicating the aperiodic trigger state by a CSI (Channel State Information) request field in the DCI; and
reporting, to the network, M-X CRI(s) based on a CSI-RS resource set associated with the aperiodic trigger state.

16. The modem chip according to claim 15, wherein X is smaller than M.

17. The modem chip according to claim 15, wherein the configured set indicates a combination of the X CRI(s) to be selected for reporting.

18. The modem chip according to claim 15, wherein the CSI-RS resource set associated with the aperiodic trigger state comprises K CSI-RS resources, wherein K is larger than or equal to M.

19. The modem chip according to claim 15, wherein the communication method further comprises:
reporting, to the network, M sets of CSI quantities other than CRI based on the CSI-RS resource set associated with the aperiodic trigger state.

20. The modem chip according to claim 19, wherein the CSI quantities other than CRI includes at least RI, PMI, and CQI.
